(19) United States
(12) Patent Application Publication
(10) Pub. No.: US 2008/0230489 A1
(43) Pub. Date: Sep. 25, 2008

(54) Device for Removing Non-Dissolved Impurities from Liquids

(76) Inventors: David Alexander Templenton, Queensland (AU); Christopher John Templenton, Queensland (AU)

Correspondence Address: DEFILLO & ASSOCIATES, INC., P.O. Box 14104, Clearwater, FL, 33766, US

(21) Appl. No.: 11/661,471

(22) PCT Filed: Aug. 26, 2004
(86) PCT No.: PCT/AU04/01138

§ 371 Date: Jan. 14, 2008

(51) Int. Cl. B01D 35/02

(52) U.S. Cl. 210/767; 210/170.03

(57) ABSTRACT

A device for use in the removal of unwanted solids from stormwater drainage systems is disclosed. The device (1) comprises a lower unit (6) and an upper unit (7). The lower unit (6) is a substantially rectangular open-topped housing with tapering sides (8, 9) to its base (10). The upper portion of each of sides (8),(9) includes a series of perforations (11, 12, 13), (14, 15, 16) across its width, the lower portion (26) of the sides (8, 9) being devoid of such perforations. The base (10) of the lower unit (6) includes a number of smaller size perforations (17). The upper unit (7) is, in top plan view, of substantially rectangular shape corresponding to that of the lower unit (6) to which it is removably fitted. The upper surface (22) of the upper unit (7) tapers downwards to an outlet (23). The outlet (23) includes a collar (24) which extends into the body of the lower unit (6). A raised essentially triangular shaped ridge (25), positioned centrally on the upper surface (22), extends substantially parallel to the longer sides of the upper unit (7) from one side of the upper unit (7) to the outlet (23). A removable water-permeable filter cloth (29) can be retained against the inner surfaces of the base (10) and sides (8, 9) of the lower unit (6).

### CROSS REFERENCE TO RELATED APPLICATION

This application is a national stage of PCT/AU2004/001138 filed Aug. 26, 2004, under the International Convention.

### FIELD OF THE INVENTION

THIS INVENTION is directed to a device for separating solids from liquids. In particular, this invention finds especial, but not limiting, use in the removal of unwanted solids from stormwater drainage systems.

### BACKGROUND OF THE INVENTION

In most cities, townships and other urban development, runoff from rain, garden or park watering systems and the like is directed to a stormwater system. Typically, a stormwater system comprises a surface drain that collects the runoff which is then directed into a grate covered pit where it is piped underground to a discharge point into a stream, lake, ocean, etc. This runoff, particularly in the first flush stage or during periods of high volume flow, tends to carry with it both floating and suspended impurities. These impurities, which can be of organic or inorganic origin, are usually considered to be pollutants which contaminate not only the stormwater drainage system itself but also the waterways and oceans into which the runoff is eventually discharged. The deposition of such pollutants is of increasing concern to the public today and Council bodies responsible for the maintenance of stormwater drainage systems are required to implement appropriate measures to improve the quality of the runoff before its discharge into the waterways and oceans.

One prior art attempt to remove these pollutants has been to install a trap at the end of the system just prior to the point of discharge into the waterway or ocean. However, such a trap is expensive to construct, install and maintain. Often, the cost of regular maintenance can be prohibitive leading to extended periods between cleaning which result in additional problems as the high concentration of impurities in the trap result in undesirable secondary reactions leading to a higher concentration of toxic substances which can then pass through the trap on the next flush of discharge water. Further, these traps only function at the discharge point into the waterway or ocean and have no mechanism to prevent any partial or complete blockage of other parts of the drainage system.

To try and redress these problems, various prior traps have been conceived for installation at the initial point of entry to the stormwater system. Such traps are described in U.S. Pat. No. 4,419,232, U.S. Pat. No. 5,232,587, U.S. Pat. No. 5,297,367, U.S. Pat. No. 5,405,539, U.S. Pat. No. 6,106,706, U.S. Pat. No. 6,231,758, US Patent Application No. 2002/0057944 and US Patent Application No. 2003/0034286. However, such traps suffer from one or more of the following disadvantages: (1) expensive to manufacture; (2) comprise a multitude of components; (3) are unable or difficult to be retrofitted into an existing catchpit; (4) are not universal ‘one size fits’ all; (5) need to be removed completely from the catchpit for servicing; (6) have moving parts that can jam, break or wear out; (7) cannot accommodate various rates of water flow into the trap, and are particularly lacking in adequate provision for bypass during periods of high water flow and/or cease to be effective during such high water flows; (8) cause an interruption to water flow when filled with trapped pollutants; (9) only trap a narrow range of pollutants and usually do not trap small floating and/or suspended pollutants such as cigarette butts, small leaves and fine sand; (10) have no provision to prevent redisbursement of floating or suspended pollutants back into the stormwater system after they have entered the trap; (11) retain water thus creating a breeding environment for undesirable insects such as mosquitos; (12) require specially shaped filters or filter bags; (13) require fixtures such as loops, lugs, clips or labour intensive means such as rivetting or tying to fasten the filtering medium to the trap; and (14) are difficult and/or expensive to clean.

### SUMMARY OF THE INVENTION

It is thus a general object of the present invention to overcome, or at least ameliorate, one or more of the above identified disadvantages.

The present inventors have established, inter alia, that non-dissolved impurities in a flowing liquid—especially, but not limited to, flowing water—can be more readily removed if the direction and/or rate of outflow of liquid from a solid/liquid separation unit can be regulated. In this regard, it has been noted that removal of such impurities is easier if the rate of outflow is lower than the initial rate of inflow.

Accordingly, as a first aspect of the present invention, there is provided a liquid flow control unit of the type having an inlet to receive flowing liquid and an outlet for exiting said flowing liquid, said liquid flow control unit including a body adapted to receive incoming said flowing liquid and regulate the flow of said flowing liquid simultaneously with or before said liquid exits said body.

Preferably, said body includes an upper portion adapted to receive said flowing liquid and a lower portion adapted to regulate said flow.

Preferably, regulation of said rate flow is determined by one or more perforations in said lower portion.

Preferably, said one or more perforations is a series of co-planar perforations.

Preferably, said series of perforations are two or more co-planar series of perforations, each co-planar series spaced from an adjacent co-planar series.

More preferably, the total area represented by any one of said series of co-planar perforations differs from the total area of an adjacent said series of co-planar perforations.

The present inventors have established that a flow control device as hereinbefore described is of particular use in separating non-dissolved impurities from a flowing liquid.

Therefore, as a second aspect of the present invention, there is provided a device of the type having a separation unit with an inlet to receive flowing liquid containing non-dissolved impurities therein and an outlet for said flowing liquid from which said impurities have been removed, said device characterised in that said separation unit includes a flow control device as hereinbefore described.

Preferably, said separation unit includes an uppermost portion in communication with said flow control unit, said uppermost portion being adapted to receive said flowing liquid containing said impurities and direct said flowing liquid containing said impurities into said flow control unit.

Preferably, said separation unit is adapted to separate said impurities from said flowing liquid received therein before said flowing liquid exits said lower portion of said flow control unit; said lower portion being further adapted to retain therein said impurities thus separated from said flowing liquid.

Preferably, said uppermost portion is adapted to direct said flowing liquid into said lower portion at a point remote from said inlet.

Preferably, said uppermost portion is adapted to direct said flowing liquid into said lower portion in a downward circular-like motion.

Preferably, said uppermost portion and said flow control unit are removably connected together.

Preferably, a removable filter medium is secured within said lower portion.

Preferably, said flowing liquid is flowing water.

As a third aspect of the present invention, there is provided a method of separating non-dissolved impurities from flowing liquid, said method including passing said flowing liquid through a device as hereinbefore described.

### BRIEF DESCRIPTION OF THE DRAWINGS

A preferred embodiment of the present invention will now be described with reference to the accompanying drawings wherein:

FIG. 1 is a schematic cross-sectional view of a device of the present invention installed in a catchpit;

FIGS. 2A, B & C are schematic side, end and base views respectively of a lower component of the device of FIG. 1;

FIG. 3A is a schematic cross-sectional view of an upper component of the device of FIG. 1;

FIG. 3B is a schematic top plan view of the upper component of FIG. 3A; and

FIG. 4 is a schematic cross-sectional view of the device of FIG. 1 in use.

### DESCRIPTION OF THE INVENTION

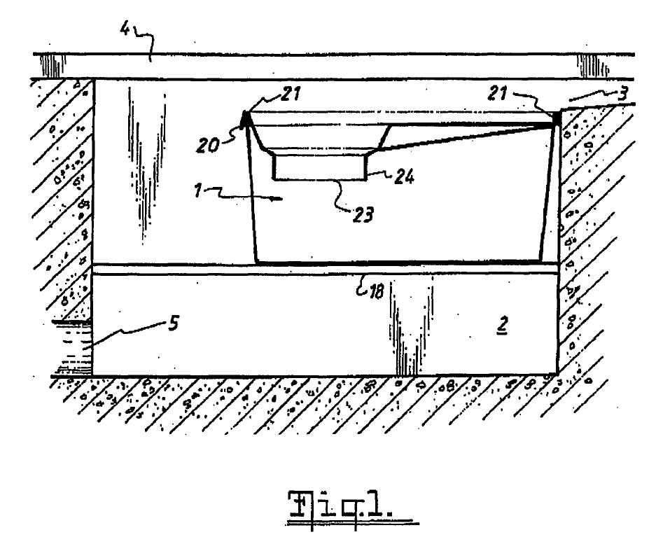

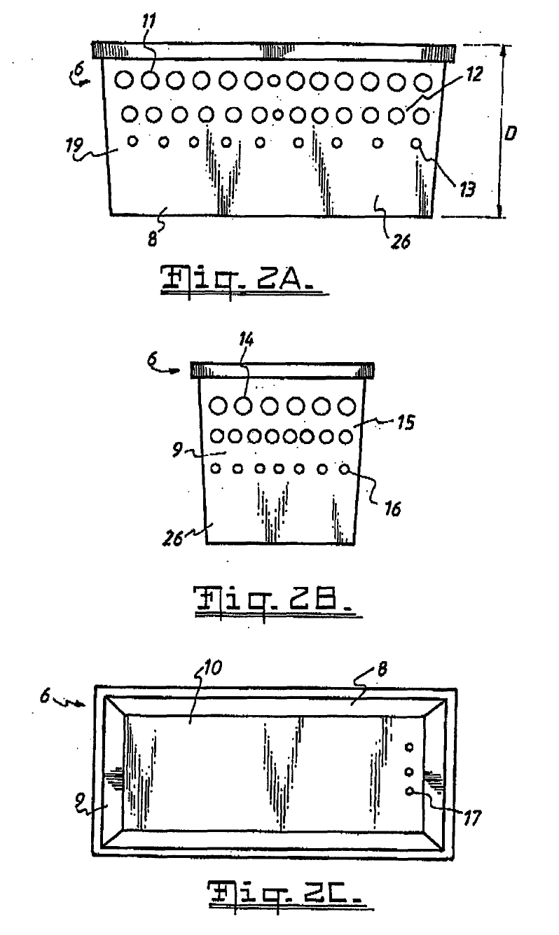

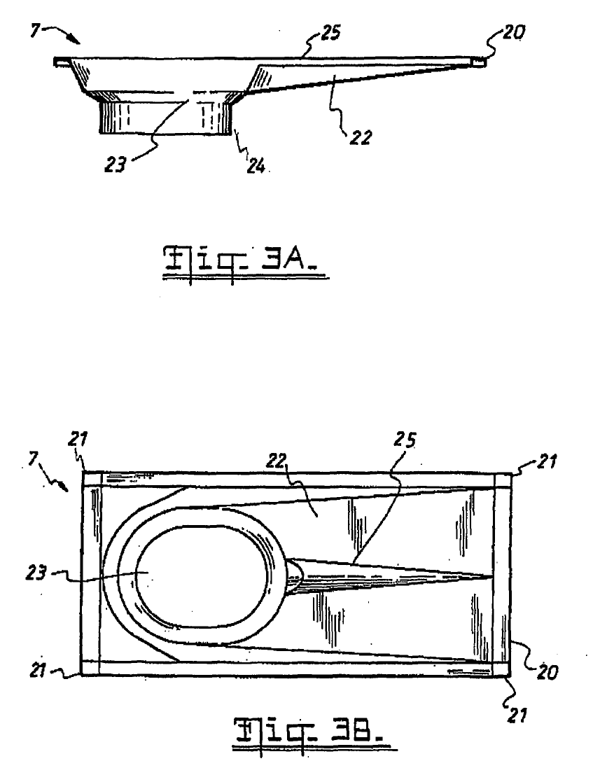

Referring to FIG. 1, the device (1) is installed in a typical catchpit (2), the catchpit (2) collecting stormwater through an inlet (3) associated with street kerbing (4). The device (1) comprises a lower unit (6) (FIGS. 2A-C) and an upper unit (7) (FIGS. 3A & B), stormwater passing over the upper unit (7) into the lower unit (6) wherein any floating and/or suspended impurities settle and then are filtered from the stormwater before it passes through the lower unit (6) to exit an outlet (5) of the catchpit (2) for piping the filtered stormwater to an ocean outfall or similar.

The lower unit (6) (FIGS. 2A-C) is a substantially rectangular open-topped housing with tapering sides (8, 9) (only one of each pair of opposed sides illustrated) to its base (10). The upper portion of each side (8) includes a series of perforations (11, 12, 13) across its width. Similarly, the upper portion of each side (9) also includes a series of perforations (14, 15, 16) across its width. The lower portion (26) of the sides (8, 9) of the unit (6) is devoid of such perforations. Perforation series (11,14), (12,15) and (13,16) are, typically, substantially equi-distant from the base (10). The total area represented by each individual series of perforations (11,14), (12,15) and (13,16) is selected such that there is a graduated reduction in this total area from the top series of perforations (11, 14) to the bottom series of perforations (13, 16). The base (10) of the lower unit (6) also includes a number of smaller size perforations (17), typically, positioned in-line and closer towards one side edge of the base (10). The base (10) rests on bars (18) fixed across opposite sides of the catchpit (2) (FIG. 1). These bars (18) are affixed at the appropriate position within the catchpit (2) to ensure that the base is above the outlet pipe (5) and any underground inlet waste water pipe(s) (not illustrated) into the catchpit (2). As the base (10) is supported by the bars (18), together with an appropriate choice of material from which the base (10) is manufactured, the base (10) can support relatively heavy loads without significant distortion.

Should the depth D (FIG. 2A) of the lower unit (6) be too great to be retrofitted to an existing catchpit (2), the lower unit (6) can be severed at an appropriate lateral position (19) and the resultant two portions nested together (affixed to each other by any suitable means, for example, stainless steel screws) to attain the required depth.

The upper unit (7) is, in top plan view (FIG. 3B), of substantially rectangular shape corresponding to that of the lower unit (6). The upper unit (7) has a partially rolled circumferential upper edge (20) which is adapted to allow a removable snap-fit type engagement with the upper edges of the sides (8, 9) of the lower unit (6). The corners (21) of the upper unit (7) are adapted to allow removable catchbolts (not illustrated) to be passed therethrough to affix the upper unit (7) to the inner walls of the catchpit (2). As the weight of the device (1) is borne by the base (10) supported on the bars (18) (FIG. 1), no downward tension is applied to the catchbolts which can thus be easily removed to enable the upper unit (7) to be readily disconnected from the lower unit (6) and lifted from the catchpit (2) when servicing of the device (1) is required.

The upper surface (22) (FIGS. 3A & B) of the upper unit (7) tapers downwards to an outlet (23). The outlet (23) includes a collar (24) which extends into the body of the lower unit (6) (FIG. 1). The taper of the upper surface is such that the outlet (23) is offset towards that side of the upper body remote from the inlet (3) of stormwater. A raised essentially triangular shaped ridge (25), positioned centrally on the upper surface (22), extends substantially parallel to the longer sides of the upper unit (7) from one side of the upper unit (7) to the outlet (23).

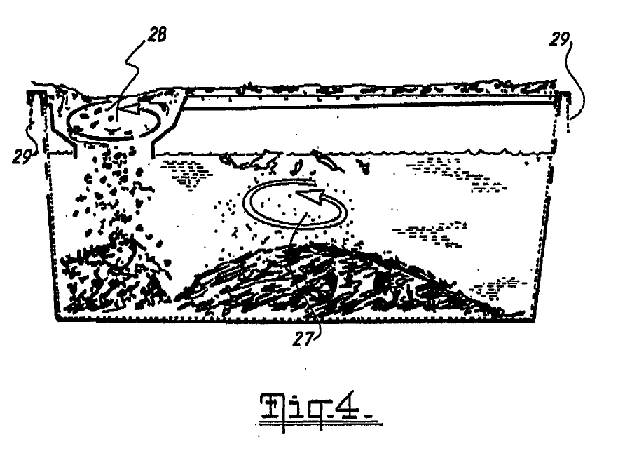

A removable water-permeable filter cloth (29) (FIG. 4) is smoothed against the inner surfaces of the base (10) and sides (8, 9) of the lower unit (6) and passed over the upper edges of the sides (8, 9) and secured between the upper edge (20) of the upper unit (7) and the upper edges of the sides (8, 9) prior to the snap-fit engagement thereof. Such a filter cloth is well known in the art. This cloth can readily be removed from the device (1) (and subsequently replaced or renewed) without the entire device (1) having first to be lifted from the catchpit (2).

Although in no way limiting, all major components of the device of the invention can be conveniently manufactured from a plastics material such as polypropylene or similar.

In use, the device (1) is installed in the catchpit (2) such that the ridge (25) is offset from the stormwater inlet (3) promoting the incoming stormwater to flow down the upper surface (22) substantially passing to one side of the ridge (25) and through the outlet (23) to enter the lower unit (6) in a downward circular motion. As the base of the lower unit (6) only includes a limited number of small-area perforations (17), and as its lower region (26) is devoid of any such perforations, when there is a significant influx of stormwater, the rate of flow of stormwater exiting the perforations (17) is lower than the rate of incoming stormwater to the lower unit (6) and the level of water present in the lower unit (6) thus rises. This motion of incoming water creates a low pressure circular-type flow (27) of water (FIG. 4) approximately centrally within the lower unit (6). Floating and suspended impurities concentrate in this low pressure region, away from the sides (8, 9) of the lower unit (6), and away from the outlet (23) of the upper unit (7). A longer period is therefore provided for settling of the suspended impurities before they come into contact with the filter medium within the lower unit (6), thus subsequently increasing their retention rate by the filter medium. Also, as the water level rises within the lower unit (6), and particularly when it passes the lower extremities of the collar (24), any floating impurities are trapped below the upper unit (7) thereby reducing the likelihood of these impurities returning back through the outlet (23).

As the water level in the lower unit (6) rises, especially during higher flow rates of incoming stormwater, the first perforation series (13,16) is reached. Water, although still filtered, can pass out through the perforations (13,16) at a rate essentially governed by the total area of the perforations (13,16).

As the water level continues to rise, the second perforation series (12,15) is reached where, once again, although still filtered, water passes therethrough but, as the total area of this second perforation series (12,15) is greater than the first perforation series (13,16), the exit flow rate is also correspondingly greater. Similar results occur should the water level reach the third perforation series (11,14).

For even higher incoming stormwater flow rates where the lower unit (6) is rapidly filled and excess stormwater passes over the upper surface (22) of the upper unit (7) and directly into the catchpit (2) (FIG. 4), a second, vortex-like flow of water (28) is created at the outlet (23). This resultant low pressure region within the outlet (23) enhances the precipitation of heavier impurities downwards through the outlet (23) into the lower unit (6) where they can still be trapped by the filter medium therein.

The flow of incoming water through the device (1) can be further modified by selecting the appropriate areas and/or positions of the various perforations (11-17). For example, as the circular perforations (17) in the base (10) are reduced in diameter and/or number, the flow of water therethrough is reduced thus providing a more efficient mechanism to filter out the impurities of a finer particle size; and if the perforations (11-16) in the sides (8, 9) are increased in number and/or diameter, and/or possibly additional perforations in the lower region (26) of the lower unit (6) are included, the rate of flow of water therethrough is increased as the device (1) fills with incoming water during a heavy flow, thus assisting in the prevention of any impurities passing directly into the outlet (5) of the catchpit (2) from overflowing of the device (1). By suitable positioning of the perforations (11-16,17), the point(s) of exit of the water can be governed relative to the initial incoming flow. The device (1) can thus be constructed to better meet the characteristics of any particular water flow and/or anticipated impurities. Further, these flow parameters of the device (1) can be altered on-site simply by drilling additional perforations into the lower unit (6) or by plugging existing perforations.

In another embodiment of the present invention, the separate cloth-like filter medium retained within the lower unit (6) can be dispensed with and the various perforations (11-17) can be selected to be sufficiently small in area to act as the filter medium trapping the impurities within the confines of the lower unit (6) while still allowing the thus-filtered water to flow through to be discharged from the catchpit (2). In this embodiment, the entire device (1) would have to be subsequently lifted from the catchpit (2) to remove the pollutants.

It will be appreciated that the lower unit (6) (FIGS. 2A-C) can function independently of the device (1) and can act as a flow control device wherever it is necessary to reduce the rate of flow of an incoming liquid into a trap or other type of containment, before allowing the trapped or contained water to exit.

The present invention, in its preferred form when fitted with the flow control device, thus provides a separation device which can be used in a gully trap, catchpit or the like and which offers at least the following advantages:
gravel and heavier particulate matter of a size carried by flowing water, finer suspended particles and floating debris, general litter and naturally-occurring debris such as leaves and twigs, and wind-borne dry pollutants such as fine sand, leaves, paper and the like can be trapped well before discharge of the water into rivers and the sea etc., thus reducing the likelihood of local flooding and also reducing maintenance costs of the system;
reduces the buildup of sand/gravel at the outfalls thus reducing the incidence of flooding, reducing expensive dredging, and offering less disruption to the ecosystem;
with the reduction of leaves and other organic materials being discharged into the waterways and the sea, there is a corresponding reduction in phosphorus and nitrogen buildup, thus encouraging a healthier waterway;
unsightly and/or dangerous floating litter such as cigarette butts and packets, small plastic bottles, discarded syringes and the like are less likely to be deposited on public accessible waterway banks and beaches;
\is relatively inexpensive to manufacture and maintain, requiring no especially shaped or sized filter bags, nor relatively expensive and/or labour intensive fixing and subsequent cleaning methods; regular removal and replacement of any filter medium used would thus be encouraged;
can be retrofitted to existing installed gully traps and catchpits;
can accommodate water ingress from low to high flows with minimum redisbursement of impurities back into the drainage system during periods of high water flow; and
when the separate filter medium is installed, it eases the effort required to remove, transport and dispose of the impurities trapped therein, personnel servicing the device not being required to come into contact with the impurities thus offering a healthier and cleaner working environment.

Although specific reference has been made to the use of one preferred form of the invention in civic water drainage systems, it will be appreciated that the present invention is not so limited and finds use in other areas where non-dissolved contaminants in a flowing liquid are required to be removed before the liquid is discharged or otherwise stored or used. One such other area of use is in the mining industry during the washing of extracted earth. Similarly, the flow control device can be used in other areas where it is necessary to reduce the rate of flow of an incoming liquid into a trap or other type of containment, before allowing the trapped or contained water to exit.

It will be appreciated that the above described embodiments are only exemplification of the various aspects of the present invention and that modifications and alterations can be made thereto without departing from the inventive concept as defined in the following claims.

1-13. (canceled)

14. A liquid flow control unit to regulate the flow of an incoming liquid simultaneously with or before said liquid exits said unit, said unit including a body having an upper portion and a lower portion, wherein:
said upper portion is adapted to receive said incoming liquid; and
said lower portion includes two or more series of perforations, each series spaced from an adjacent series, the total area represented by any one of said series of perforations differing from the total area of an adjacent said series of perforations.

15. A liquid flow control unit as defined in claim 14 wherein, said total area of an upper of said one series of perforations is greater than said total area of a lower of said adjacent series of perforations.

16. A liquid flow control unit as defined in claim 14, wherein said flowing liquid is flowing water.

17. A device of the type having a separation unit with an inlet to receive flowing liquid containing non-dissolved impurities therein and an outlet for said flowing liquid from which said impurities have been removed, said device characterised in that said separation unit includes a flow control unit as defined in claim 14.

18. A device as defined in claim 17 wherein, said separation unit includes an uppermost portion in communication with said flow control unit, said uppermost portion being adapted to receive said flowing liquid containing said impurities and direct said flowing liquid containing said impurities into said flow control unit.

19. A device as defined in claim 17 wherein, said separation unit is adapted to separate said impurities from said flowing liquid received therein before said flowing liquid exits said lower portion of said flow control unit; said lower portion being further adapted to retain therein said impurities thus separated from said flowing liquid.

20. A device as defined in claim 18 wherein, said separation unit is adapted to separate said impurities from said flowing liquid received therein before said flowing liquid exits said lower portion of said flow control unit; said lower portion being further adapted to retain therein said impurities thus separated from said flowing liquid.

21. A device as defined in claim 18 wherein, said uppermost portion is adapted to direct said flowing liquid into said lower portion at a point remote from said inlet.

22. A device as defined in claim 19 wherein, said uppermost portion is adapted to direct said flowing liquid into said lower portion at a point remote from said inlet.

23. A device as defined in claim 21 wherein, said uppermost portion is adapted to direct said flowing liquid into said lower portion in a downward circular-like motion.

24. A device as defined in claim 22 wherein, said uppermost portion is adapted to direct said flowing liquid into said lower portion in a downward circular-like motion.

25. A device as defined in claim 17 wherein, said uppermost portion and said flow control unit are removably connected together.

26. A device as defined in claim 25 wherein, a removable filter medium is secured within said lower portion.

27. A device as defined in claim 17 wherein, said flowing liquid is flowing water.

28. A method of separating non-dissolved impurities from flowing liquid, said method including passing said flowing liquid through a device as defined in claim 17.

29. A liquid flow control unit of the type having an inlet to receive flowing liquid and an outlet for exiting said flowing liquid, said liquid flow control unit including a body having an upper portion adapted to receive incoming said flowing liquid and a lower portion adapted to regulate the flow of said flowing liquid simultaneously with or before said liquid exits said body by controlling the direction of said flow of said liquid exiting said body such that the rate of flow of said liquid as it exits said body is less than the rate of flow of said incoming liquid.

30. A liquid flow control unit as defined in claim 29, wherein said flowing liquid is flowing water.

31. A device of the type having a separation unit with an inlet to receive flowing liquid containing non-dissolved impurities therein and an outlet for said flowing liquid from which said impurities have been removed, said device characterised in that said separation unit includes a flow control unit as defined in claim 29.

32. A device as defined in claim 31 wherein, said separation unit includes an uppermost portion in communication with said flow control unit, said uppermost portion being adapted to receive said flowing liquid containing said impurities and direct said flowing liquid containing said impurities into said flow control unit.

33. A device as defined in claim 31 wherein, said separation unit is adapted to separate said impurities from said flowing liquid received therein before said flowing liquid exits said lower portion of said flow control unit; said lower portion being further adapted to retain therein said impurities thus separated from said flowing liquid.

34. A device as defined in claim 32 wherein, said separation unit is adapted to separate said impurities from said flowing liquid received therein before said flowing liquid exits said lower portion of said flow control unit; said lower portion being further adapted to retain therein said impurities thus separated from said flowing liquid.

35. A device as defined in claim 32 wherein, said uppermost portion is adapted to direct said flowing liquid into said lower portion at a point remote from said inlet.

36. A device as defined in claim 33 wherein, said uppermost portion is adapted to direct said flowing liquid into said lower portion at a point remote from said inlet.

37. A device as defined in claim 35 wherein, said uppermost portion is adapted to direct said flowing liquid into said lower portion in a downward circular-like motion.

38. A device as defined in claim 36 wherein, said uppermost portion is adapted to direct said flowing liquid into said lower portion in a downward circular-like motion.

39. A device as defined in claim 31 wherein, said uppermost portion and said flow control unit are removably connected together.

40. A device as defined in claim 39 wherein, a removable filter medium is secured within said lower portion.

41. A device as defined in claim 31 wherein, said flowing liquid is flowing water.

42. A method of separating non-dissolved impurities from flowing liquid, said method including passing said flowing liquid through a device as defined in claim 31.
